(19) United States
(12) Patent Application Publication
(10) Pub. No.: US 2024/0036247 A1
(43) Pub. Date: Feb. 1, 2024

(54) BACKLIGHT MODULE AND DISPLAY PANEL

(71) Applicant: WUHAN CHINA STAR OPTOELECTRONICS TECHNOLOGY CO., LTD., Wuhan, Hubei (CN)

(72) Inventors: Dong Tian, Wuhan, Hubei (CN); Gege Zhou, Wuhan, Hubei (CN); Wei Zhou, Wuhan, Hubei (CN); Jianfeng Yuan, Wuhan, Hubei (CN); Zhifu Li, Wuhan, Hubei (CN)

(73) Assignee: WUHAN CHINA STAR OPTOELECTRONICS TECHNOLOGY CO., LTD., Wuhan, Hubei (CN)

(21) Appl. No.: 17/597,950

(22) PCT Filed: Jan. 21, 2022
(86) PCT No.: PCT/CN2022/073085

§ 371 Date: Jan. 30, 2022

(30) Foreign Application Priority Data
Jan. 10, 2022 (CN) 202210024923.5

(51) Int. Cl. F21V 8/00; G02F 1/13357

(52) U.S. Cl. CPC G02B 6/0091; G02B 6/0016; G02B 6/0021; G02B 6/0073; G02B 6/0068; G02F 1/133615; G02F 1/133621

(57) ABSTRACT

A backlight module and a display panel are provided. The display panel includes a main body and a backlight module. The backlight module includes a light source and a light guide plate. By accommodating a light-emitting chip of the light source into a groove of the light guide plate, misalignment of the light source and the light guide plate is prevented so that a relative positional relationship between the light source and the light guide plate is always consistent, thereby improving the consistency and stability of the light effect of a lamp port of the backlight module.

### FIELD OF INVENTION

The present invention relates to a field of display technology, and particularly relates to a backlight module and a display panel.

### BACKGROUND OF INVENTION

Due to advantages of low operating voltage, low power consumption, flexible display mode, and low radiation, liquid crystal display (LCD) technology is widely applied in various fields, such as computers, mobile phones, televisions, and measurement displays. An LCD panel usually includes a main body and a backlight module. The main body of the LCD panel includes an array substrate, a color filter substrate, and a liquid crystal layer sandwiched between these two substrates. The backlight module is configured to provide the light required for displaying images by the main body of the LCD panel.

### Technical Problem

In a current backlight module, a light source is usually attached to a side plate of a casing of a backlight module to reduce a width of a lamp port of the backlight module. However, the disadvantage is that because the light bar of the light source is very soft, after it is attached to the side plate of the casing, the relative positional relationship between the light source and the light guide plate is not constant. Furthermore, there is a gap between the light source and the light guide plate, and a fluctuation of the side plate of the casing can easily cause a misalignment of a light-emitting surface of the light source and a light-incident surface of the light guide plate, resulting in poor light efficiency of the lamp port.

As mentioned above, the current backlight module has a problem that the light source and the light guide plate are prone to misalignment. Therefore, it is necessary to provide a backlight module and a display panel to solve this defect.

### SUMMARY OF INVENTION

Embodiments of the present application provide a backlight module and a display panel, which can solve the problem that the light source and the light guide plate of the current backlight module are prone to misalignment.

An embodiment of the present application provides a backlight module, including: a light source comprising a circuit board and a plurality of light-emitting chips, wherein the plurality of light-emitting chips are disposed on the circuit board; and a light guide plate comprising a side surface, a light-emitting surface, and a bottom surface opposite to the light-emitting surface, wherein opposite ends of the side surface are respectively connected to the light-emitting surface and the bottom surface, and wherein the light guide plate further comprises at least one groove defined on the side surface, and the groove accommodates the light-emitting chip.

According to an embodiment of the present application, the light-emitting chip is in direct contact with an inner wall of the groove.

According to an embodiment of the present application, the groove is filled with an optical adhesive, and the light-emitting chip is encapsulated in the groove by the optical adhesive.

According to an embodiment of the present application, a refractive index of the optical adhesive and a refractive index of the light guide plate are both greater than or equal to 1.5 and less than or equal to 1.55.

According to an embodiment of the present application, in a length direction of the circuit board, the groove penetrates from one end of the side surface of the light guide plate to another end of the side surface.

According to an embodiment of the present application, a number of the at least one groove is plural, and the plurality of grooves are distributed at intervals along a length direction of the circuit board.

According to an embodiment of the present application, the light source includes a plurality of light-emitting units, wherein the plurality of light-emitting chips includes a red light-emitting chip, a green light-emitting chip, and a blue light-emitting chip, wherein the plurality of light-emitting units includes at least two of the red light-emitting chip, the green light-emitting chip, or the blue light-emitting chip; and wherein each groove accommodates at least one of the plurality of light-emitting units.

According to an embodiment of the present application, the backlight module includes a casing, wherein the casing includes a bottom plate and a side plate, and wherein the bottom plate and the side plate are encircled to form an accommodating groove, and both the light source and the light guide plate are arranged in the accommodating groove.

According to an embodiment of the present application, the side surface of the light guide plate faces an inner wall of the side plate.

An embodiment of the present application further provides a display panel. The display panel includes a main body and a backlight module, the display panel is disposed on a light-emitting side of the backlight module, and the backlight module includes: a light source including a circuit board and a plurality of light-emitting chips, wherein the plurality of light-emitting chips are disposed on the circuit board; and a light guide plate including a side surface, a light-emitting surface, and a bottom surface opposite to the light-emitting surface, wherein opposite ends of the side surface are respectively connected to the light-emitting surface and the bottom surface, and wherein the light guide plate further includes at least one groove defined on the side surface, and the groove accommodates the plurality of light-emitting chips.

According to an embodiment of the present application, the light-emitting chip is in direct contact with an inner wall of the groove.

According to an embodiment of the present application, the groove is filled with an optical adhesive, and the light-emitting chip is encapsulated in the groove by the optical adhesive.

According to an embodiment of the present application, a refractive index of the optical adhesive and a refractive index of the light guide plate are both greater than or equal to 1.5 and less than or equal to 1.55.

According to an embodiment of the present application, in a length direction of the circuit board, the groove penetrates from one end of the side surface of the light guide plate to another end of the side surface.

According to an embodiment of the present application, a number of the at least one groove is plural, and the plurality of grooves are distributed at intervals along a length direction of the circuit board.

According to an embodiment of the present application, the light source includes a plurality of light-emitting units, wherein the plurality of light-emitting chips include a red light-emitting chip, a green light-emitting chip, and a blue light-emitting chip, wherein the plurality of light-emitting units include at least two of the red light-emitting chip, the green light-emitting chip, or the blue light-emitting chip; and wherein each groove accommodates at least one of the plurality of light-emitting units.

According to an embodiment of the present application, the backlight module includes a casing, the casing includes a bottom plate and a side plate, and wherein the bottom plate and the side plate are encircled to form an accommodating groove, and both the light source and the light guide plate are arranged in the accommodating groove.

According to an embodiment of the present application, the side surface of the light guide plate faces an inner wall of the side plate.

According to an embodiment of the present application, the main body includes a display area, and a minimum distance between the display area and an edge of the backlight module is less than or equal to 1.5 mm.

According to an embodiment of the present application, the main body includes a color filter substrate, an array substrate disposed opposite to the color filter substrate, and a liquid crystal layer disposed between the color filter substrate and the array substrate.

### Beneficial Effect

The beneficial effects are:

Embodiments of the present application provide a backlight module and a display panel. The display panel includes a main body and the backlight module. The backlight module includes a light source and a light guide plate, and the light guide plate includes a side surface, a light-emitting surface, and a bottom surface arranged opposite to the light-emitting surface. The opposite ends of the side surface are respectively connected to the light-emitting surface and the bottom surface. The light guide plate further includes at least one groove defined on the side surface thereof. The groove accommodates a plurality of light-emitting chips. The light-emitting chip of the light source is accommodated in the groove to prevent the misalignment of the light source and the light guide plate. Therefore, a relative positional relationship between the light source and the light guide plate is always consistent, thereby improving the consistency and stability of the light emitting effect of the lamp port of the backlight module.

### DESCRIPTION OF DRAWINGS

In order to illustrate the technical solutions in embodiments of the present application or in the prior art more clearly, the following briefly introduces accompanying drawings that need to be used in the description of the embodiments or in the prior art. Obviously, the drawings in the following description are only some embodiments disclosed. For those of ordinary skill in the art, other drawings can also be obtained from these drawings without doing a creative effort.

FIG. 1 is a schematic partial structural diagram of a first backlight module provided by an embodiment of the present application.

FIG. 2 is a schematic partial structural diagram of a second backlight module provided by an embodiment of the present application.

FIG. 3 is a top view and a front view of a first light guide plate and a light source provided in an embodiment of the present application.

FIG. 4 is a schematic plan view of a light source provided by an embodiment of the present application.

FIG. 5 is a schematic structural diagram of a second light guide plate and a light source provided by an embodiment of the present application.

FIG. 6 is a schematic structural diagram of a display panel according to an embodiment of the present application.

### DETAILED DESCRIPTION OF PREFERRED EMBODIMENTS

The following description of the embodiments refers to the accompanying drawings to illustrate specific embodiments in which the present disclosure may be practiced. The directional terms mentioned in the present disclosure, such as “upper”, “lower”, “front”, “rear”, “left”, “right”, “inner”, “outer”, “side”, etc., are only references to the directions of the attached drawings. Accordingly, the directional terms are used to describe and understand the present disclosure, rather than to limit the present disclosure. In the figures, structurally similar elements are denoted by the same reference numerals.

The present disclosure will be further described below with reference to the accompanying drawings and specific embodiments:

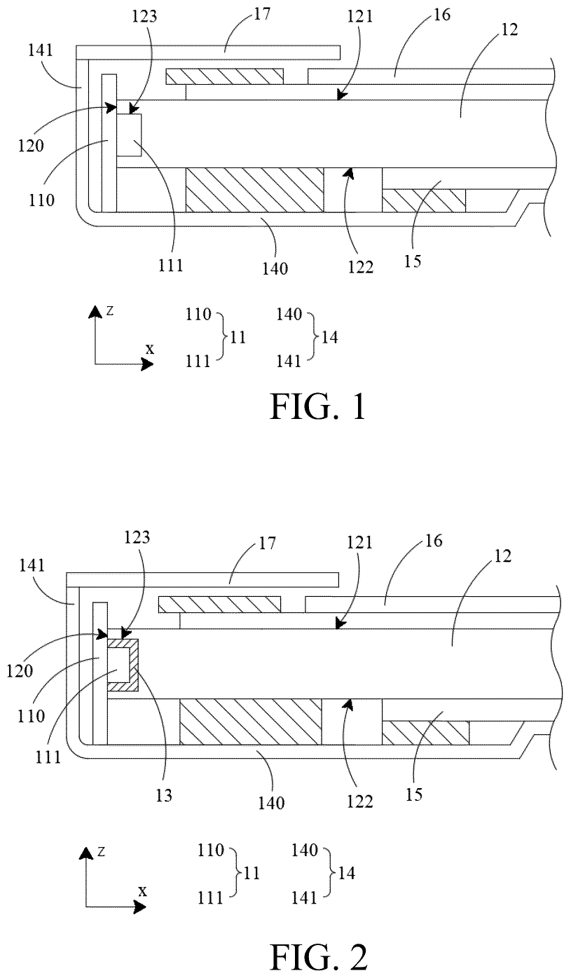

The embodiments of the present application provide a backlight module. As shown in FIG. 1, it is a schematic partial structural diagram of a first backlight module provided by an embodiment of the present application. The backlight module includes a light source 11 and a light guide plate 12. The light source 11 includes a circuit board 110 and a plurality of light-emitting chips 111, and the plurality of light-emitting chips 111 are disposed on the circuit board 110 along a length direction of the circuit board 110.

The light guide plate 12 includes a side surface 120, a light-emitting surface 121, and a bottom surface 122 arranged opposite to the light-emitting surface 121. The opposite ends of the side surface 120 are respectively connected to the light-emitting surface 121 and the bottom surface 122. The light guide plate 12 further includes at least one groove 123 recessed into the side surface 120 of the light guide plate 12, and the groove 123 accommodates the plurality of light-emitting chips 111.

The light-emitting chip 111 of the light source 11 is accommodated in the groove 123 of the side surface 120 of the light guide plate 12 so when the light source 11 is powered on and works, the light emitted by the light-emitting chip 111 can enter the light guide plate 12. In addition, due to the fixed and limiting effect of the groove 123 on the light-emitting chip 111, the relative positions of the light source 11 and the light guide plate 12 are fixed and always consistent. Even if the backlight module is shaken, the light-emitting surface of the light source 11 and the light-incident surface of the light guide plate 12 will not be misaligned, so that the consistency and stability of the light effect of the lamp port of the backlight module can be improved.

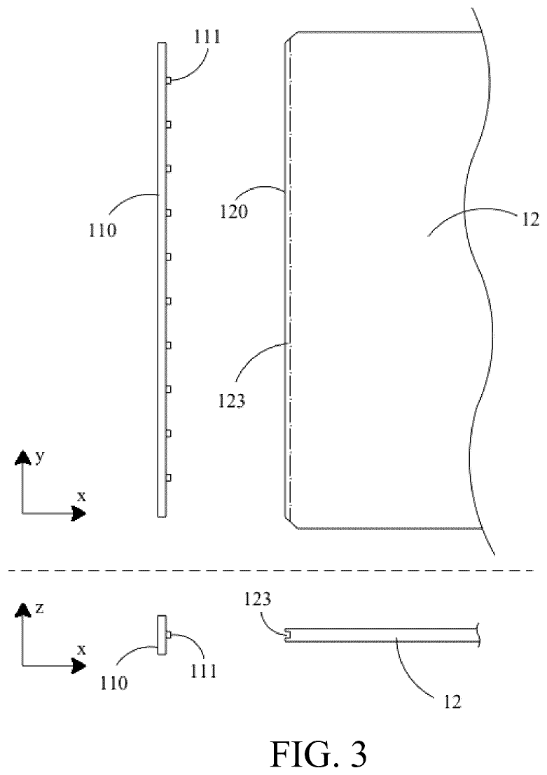

In one embodiment, as shown in FIG. 3, it is a top view and a front view of the first light guide plate and the light source provided by an embodiment of the present application, wherein the part above the dotted line is the top view, that is, the viewing angle of the light guide plate 12 and the light source 11 along the third direction z. The part below the dotted line is the front view, that is, the viewing angle of the light guide plate 12 and the light source 11 along the second direction y. Light source 11 is a strip light source and includes a plurality of light-emitting chips 111. The circuit board 110 is in a shape of a long strip. A plurality of the light-emitting chips 111 are disposed on the circuit board 110 at intervals along the length direction of the circuit board 110 and are electrically connected to circuits on the circuit board 110 to form the strip light source.

In an embodiment of the present application, as shown in FIG. 3, the light guide plate 12 is a rectangular parallelepiped. The light-emitting surface 121 and the bottom surface 122 of the light guide plate 12 are both parallel to a plane defined by the first direction x and the second direction y, and the third direction z is perpendicular to the plane defined by the first direction x and the second direction y. The side surface 120 of the light guide plate 12 is parallel to the third direction z, and a length direction of the circuit board 110 is the second direction y.

The light guide plate 12 may have four side surfaces respectively connected to the light-emitting surface 121 and the bottom surface 122. The four sides are all perpendicular to the plane defined by the first direction x and the second direction y, and parallel to the third direction z. The side surface 120 with the groove 123 is only one of the plurality of side surfaces of the light guide plate 12.

In one embodiment, the circuit board 110 is a flexible printed circuit (FPC), and the light-emitting chip 111 can be directly mounted on the circuit board 110. Both the light-emitting chip 111 and the circuit board 110 can be fixedly connected to the light guide plate 12, so the relative positional relationship between the light-emitting chip 111 and the circuit board 110 and the light guide plate 12 is constant. Even though the material of the flexible printed circuit board is very soft, the relative positional relationship between the light-emitting chip 111 and the light guide plate 12 will not be affected.

In practical applications, the circuit board 110 is not limited to the flexible printed circuit board in the above-mentioned embodiment, but can also be a rigid printed circuit board (PCB).

In one embodiment, the light source 11 may also be a point light source. The light source 11 includes a circuit board 110 and a plurality of light-emitting chips 111 are centrally arranged on a certain area of the circuit board 110. The light guide plate 12 may include only one groove 123, and the plurality of light-emitting chips 111 may be accommodated in the groove 123.

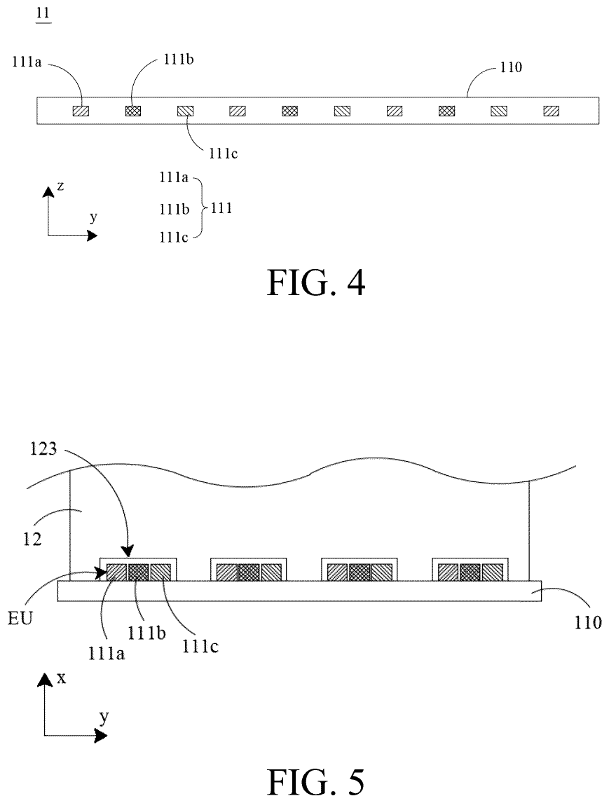

In one embodiment, as shown in FIG. 4, which is a side view of the light source provided by the embodiment of the present application. The light-emitting chip 111 may be a micro light-emitting diode (Micro LED) or a mini light-emitting diode (Mini LED). The light-emitting chip 111 may include a red light-emitting chip 121, a green light-emitting chip 122, and a blue light-emitting chip 123. The light emitted by the red, green, and blue light-emitting chips are mixed to form white light. Compared with the white light-emitting diode (LED) used as the light source in the traditional backlight module, the size of the Micro LED or the Mini LED is smaller, which is more conducive to reducing the width of the lamp port of the backlight module.

In practical applications, the types of the light-emitting chips 111 are not limited to the above-mentioned red, green, and blue light-emitting chips, and may also include white light-emitting chips.

In one embodiment, as shown in FIG. 1, the light-emitting chip 111 is in direct contact with the inner wall of the groove 123. The light-emitting chip 111 is accommodated in groove 123 of the light guide plate by injection molding. In the actual production process, a plurality of light-emitting chips 111 can be bonded on the circuit board 110 to form the light source 11, and then the light source 11 is placed in the mold. Then, materials such as PC or PMMA are injected into the mold through the injection molding process, and after the materials are cooled, the light guide plate 12 can be formed, and the light source 11 is directly fixed on the light guide plate 12. In the process of injection molding, groove 123 is formed after the material covering the light-emitting chip 111 is cooled. There is no gap between the inner wall of groove 123 and the light-emitting chip 111, and the light-emitting chip 111 can be in direct contact with the inner wall of groove 123.

When the light guide plate 12 is formed by injection molding, the light-emitting chip 111 is encapsulated in the light guide plate 12, and the light source 11 and the light guide plate 12 can be fixed without using an optical adhesive. Furthermore, there is no gap between the light source 11 and the light guide plate 12, so that all the light emitted by the light source 11 can enter the light guide plate 12 to avoid light leakage, and improve the light utilization rate of the backlight module. In addition, the relative positional relationship between the light source 11 and the light guide plate 12 can be fixed and always consistent, which can avoid the misalignment of the light-emitting surface of the light source 11 and the light-incident surface of the light guide plate 12. Therefore, the consistency and stability of the light effect of the lamp port of the backlight module can be improved.

In one embodiment, as shown in FIG. 2, which is a schematic partial structural diagram of a second backlight module provided by an embodiment of the present application. The groove 123 of the light guide plate 12 is filled with optical adhesive 13. The light-emitting chip 111 is encapsulated in groove 123 by the optical adhesive 13, and the circuit board 110 can also be bonded to the side 120 of the light guide plate 12 by the optical adhesive.

It should be noted that, because the light-emitting chip 111 is a Micro LED or Mini LED, which is small and is not be encapsulated, the light-emitting chip 111 is easily damaged by high temperature and high pressure during the injection molding of the light guide plate 12. In the embodiment shown in FIG. 2, the optical adhesive 13 is filled in groove 123, and the light-emitting chip 111 embedded in the groove 123 is fixed and encapsulated by the optical adhesive 13. In this way, damage to the light-emitting chip 111 can be avoided.

Further, the refractive indices of the optical adhesive 13 and the light guide plate 12 are both greater than or equal to 1.5 and less than or equal to 1.55. The refractive index of the optical adhesive 13 may be equal to or close to the refractive index of the light guide plate 12. For example, the refractive indices of the optical adhesive 13 and the light guide plate 12 may both be 1.5, 1.52, 1.53, 1.54, or 1.55, etc., that is, between 1.5 and 1.55. In this way, the refraction of light at the interface between the optical adhesive 13 and the light guide plate 12 can be reduced thereby reducing the loss of light in the process of entering the light guide plate 12 from the optical adhesive 13. Therefore, the light utilization rate of the backlight module is improved.

In one embodiment, as shown in FIG. 3, light source 11 is a strip light source. In a length direction of the circuit board 110 (i.e., the second direction y), the groove 123 penetrates from one end of the side surface 120 of the light guide plate 12 to an opposite end of the side surface 120 so that groove 123 is in a shape of a long strip suitable for the light source 11. Therefore, it is convenient to accommodate a plurality of the light-emitting chips 111 on the light source 11 in the same groove 123.

In one embodiment, the light source 11 may include a plurality of light-emitting units. Each of the light-emitting units is composed of at least two of the red light-emitting chip, the green light-emitting chip, or the blue light-emitting chip. The light guide plate 12 may include a plurality of grooves 123 spaced along the length direction of the circuit board, and each of the grooves 123 accommodates at least one of the light-emitting units.

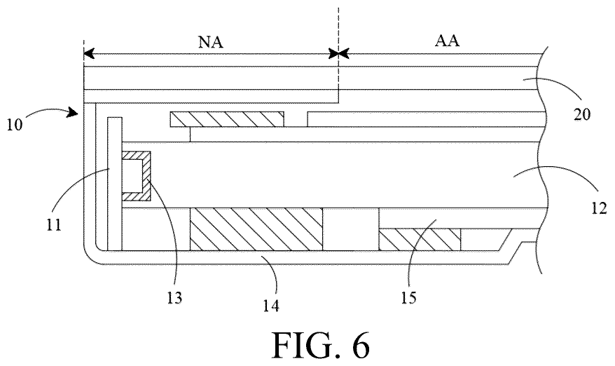

As shown in FIG. 5. FIG. 5 is a schematic structural diagram of a second light guide plate provided by an embodiment of the application. The light source 11 includes a plurality of light-emitting units EU. The light-emitting chip 111 includes a red light-emitting chip 111a, a green light-emitting chip 111b, and a blue light-emitting chip 111c. Each of the light-emitting units EU is composed of a red light-emitting chip 111a, a green light-emitting chip 111b, and a blue light-emitting chip 111c, which are arranged adjacently.

The light guide plate 12 may include a plurality of grooves 123 spaced along the length direction of the circuit board, and each of the grooves 123 accommodates one of the light-emitting units EU.

In practical applications, the composition of the light-emitting unit EU is not limited to the above-mentioned embodiment. The light-emitting unit may also consist of only one red light-emitting chip 111a and one green light-emitting chip 111b, or it is composed of a red light-emitting chip 111a and a blue light-emitting chip 111c, or a green light-emitting chip 111b and a blue light-emitting chip 111c. The number of light-emitting units that can be accommodated in each of the grooves 123 is not limited to one in the above embodiments, and each of the grooves 123 can also accommodate two or more light-emitting units.

It can be understood that, if the receiving cavity 121 is configured to include a plurality of grooves 123 arranged at intervals, it is necessary to align the plurality of light-emitting chips 111 with the plurality of grooves 123. Because the size of the light-emitting chip 111 is small, the requirements for the injection molding process of the light guide plate 12, the processing accuracy, and the assembly process of the light source 11 and the light guide plate 12 are relatively high. In addition, there is a risk that the light-emitting chip 111 is not assembled into the groove 123, resulting in the poor optical performance of the backlight module. The groove 123 is defined to be a through-groove structure, and a plurality of the light-emitting chips 111 are accommodated in the groove 123 so the requirements for the injection molding process of the light guide plate 12, the processing accuracy, and the alignment accuracy between the light-emitting chips 111 and the groove 123 can be lower. Furthermore, the assembly difficulty of the light source 11 and the light guide plate 12 can also be reduced.

Further, as shown in FIG. 1, the backlight module includes a casing 14. The casing 14 includes a flat bottom plate 140 and a plurality of side plates 141 formed by bending an outer periphery of the bottom plate 140 along a thickness direction of the backlight module. The bottom plate 140 and the plurality of side plates 141 are encircled to form an accommodating groove of a semi-enclosed structure, and the light source 11 and the light guide plate 12 are both disposed in the accommodating groove.

In one embodiment, the bottom plate 140 and the side plate 141 are integrally formed, so that the integrity and rigidity of the casing 14 can be improved.

In one embodiment, both the bottom plate 140 and the side plate 141 may be independent components. The side plate 141 is detachably mounted on the bottom plate 140, and the mounting method of the side plate 141 and the bottom plate 140 includes but is not limited to the manner of snap-fit or screw connection.

Specifically, one or more detachable side plates 141 may be provided with integrally formed buckles. Slots corresponding to the buckles are provided on the bottom plate or other side plates, and the buckles are engaged with the slots to install the detachable side plates 141.

In practical applications, the side plate 141 can also be fixedly connected to the bottom plate 140 by means of adhesive.

In one embodiment, the material of casing 14 is metal, so that the casing 14 has good rigidity. This can prevent the casing 14 from being deformed when it is subjected to an external force, which may cause damage to the internal components such as light source 11 and light guide plate 12.

In the embodiment of the present application, as shown in FIG. 1. The light guide plate 12 is an edge-type light guide plate, and light source 11 is an edge-type light source. The side surface 120 of the light guide plate 12 faces the inner wall of the side plate 141 and the light source 11 is arranged on the side of the light guide plate close to the side plate 141. Compared with the direct-type light guide plate, the edge-type light guide plate does not need to have a light mixing space, which can reduce the thickness of the backlight module. Furthermore, the light-emitting chip 111 of the light source 11 is embedded into the groove 123 of the side surface 120 of the light guide plate 12, which can eliminate the gap between the light source 11 and the light guide plate 12 so that all the light emitted by the light source 11 can enter the light guide plate 12. This improves the utilization of light and reduces the width of the lamp port of the backlight module.

Furthermore, the backlight module further includes a reflector 15, and the reflector 15 is disposed on the bottom surface 122 of the light guide plate 12. The reflector 15 is used to reflect the light irradiated on the bottom surface 122 of the light guide plate 12 back into the light guide plate 12, so that the light can continue to be transmitted in the light guide plate 12, thereby reducing light loss and improving the light utilization rate of the backlight module.

In one embodiment, the reflector 15 is a reflective sheet or a reflective plate made of a metal material. In practical applications, the reflector 15 is not limited to the reflective sheet or reflective plate in the above-mentioned embodiment, but can also be a reflective coating directly formed on the bottom of the light guide plate 12 by dispensing or evaporation process. The material of the reflective coating can also be metal or non-metallic material with a reflective effect.

Further, in the embodiment of the present application, the backlight module further includes an optical film 16, and the optical film 16 is disposed on the light-emitting side of the light guide plate 12. The optical film 16 may include but is not limited to, at least one of the optical films such as a diffuser film, a brightness enhancement film, or a prism film.

Further, in the embodiment of the present application, the backlight module further includes a light-shielding adhesive 17. The light-shielding adhesive 17 can be disposed on the side of the optical film 16 away from the light guide plate 12 and covers the area of the backlight module corresponding to the non-display area of the display panel main body, which is used to block the light guide plate 12, the reflector 15, the light source 11, and other components in the backlight module to prevent the backlight module from leaking light in the area of the lamp port.

It should be noted that the parts filled with oblique lines in the same direction in FIG. 1 and FIG. 2 are viscous foam glues, which are used to support and fix components such as the light guide plate 12 and the reflector 15 in the backlight module.

An embodiment of the present application further provides a display panel. As shown in FIG. 6, it is a schematic structural diagram of a display panel provided by an embodiment of the present application. The display panel includes a main body 20 and a backlight module 10. The main body 20 is a liquid crystal display panel. The main body 20 may include a color filter substrate and an array substrate disposed opposite to the color filter substrate, and a liquid crystal layer disposed between the color filter substrate and the array substrate.

The main body 20 is disposed on the light-emitting side of the backlight module 10, and the main body 20 can be attached to the backlight module 10 through an optical adhesive.

In the embodiment of the present application, the backlight module 10 may be the backlight module shown in FIG. 1 to FIG. 4 as mentioned in the above-mentioned embodiment. The main body 20 of the display panel includes a display area NA and a non-display area NA surrounding the display area AA. The width of the non-display area NA is the distance between the display area NA of the main body 20 and the edge of the backlight module 10. After the assembly of the main body 20 and the backlight module 10 is completed, due to the reduction of the structural width of the lamp port of the backlight module 10 as mentioned in the above embodiment, the distance between the main body 20 and the edge of the backlight module 10 can be limited within 1.5 mm, thereby effectively reducing the width of the lower frame of the display panel.

An embodiment of the present application further provides an electronic device, where the electronic device includes the display panel provided by the above embodiments. In this embodiment of the present application, the electronic device may be a mobile terminal, such as a smartphone, a tablet computer, a notebook computer, or the like. The electronic device can also be a wearable terminal, such as a smartwatch, smart bracelet, smart glasses, augmented reality device, or the like. The electronic device may also be a stationary terminal, such as a desktop computer, a television, or the like.

Embodiments of the present application provide a backlight module and a display panel. The display panel includes a main body and the backlight module. The backlight module includes a light source and a light guide plate, and the light guide plate includes a side surface, a light-emitting surface, and a bottom surface arranged opposite to the light-emitting surface. The opposite ends of the side surface are respectively connected to the light-emitting surface and the bottom surface. The light guide plate further includes at least one groove defined on the side surface thereof. The groove accommodates a plurality of light-emitting chips. The light-emitting chip of the light source is accommodated in the groove to prevent the misalignment of the light source and the light guide plate. Therefore, the relative positional relationship between the light source and the light guide plate is always consistent, thereby improving the consistency and stability of the light effect of the lamp port of the backlight module.

As mentioned above, the present application discloses the above contents with preferred embodiments. However, the above-mentioned preferred embodiments are not intended to limit the present application. Those of ordinary skill in the art can make various changes and modifications without departing from the spirit and scope of the present application. The protection scope of the present application is based on the scope defined by the claims.

What is claimed is:

1. A backlight module, comprising:
a light source comprising a circuit board and a plurality of light-emitting chips, wherein the plurality of light-emitting chips are disposed on the circuit board; and
a light guide plate comprising a side surface, a light-emitting surface, and a bottom surface opposite to the light-emitting surface, wherein opposite ends of the side surface are respectively connected to the light-emitting surface and the bottom surface, and wherein the light guide plate further comprises at least one groove defined on the side surface, and the at least one groove accommodates the plurality of light-emitting chips.

2. The backlight module of claim 1, wherein each light-emitting chip is in direct contact with an inner wall of each groove.

3. The backlight module of claim 1, wherein each groove is filled with an optical adhesive, and each light-emitting chip is encapsulated in the groove by the optical adhesive.

4. The backlight module of claim 3, wherein a refractive index of the optical adhesive and a refractive index of the light guide plate are both greater than or equal to 1.5 and less than or equal to 1.55.

5. The backlight module of claim 3, wherein in a length direction of the circuit board, the groove penetrates from one end of the side surface of the light guide plate to another end of the side surface.

6. The backlight module of claim 1, wherein a number of the at least one groove is plural, and the plurality of grooves are distributed at intervals along a length direction of the circuit board.

7. The backlight module of claim 2, wherein the light source comprises a plurality of light-emitting units, wherein the plurality of light-emitting chips comprise a red light-emitting chip, a green light-emitting chip, and a blue light-emitting chip, wherein the plurality of light-emitting units comprise at least two of the red light-emitting chip, the green light-emitting chip, or the blue light-emitting chip; and
wherein each groove accommodates at least one of the plurality of light-emitting units.

8. The backlight module of claim 1, further comprising a casing, wherein the casing comprises a bottom plate and a side plate, and wherein the bottom plate and the side plate are encircled to form an accommodating groove, and both the light source and the light guide plate are arranged in the accommodating groove.

9. The backlight module of claim 8, wherein the side surface of the light guide plate faces an inner wall of the side plate.

10. A display panel comprising a main body and a backlight module, wherein the main body is disposed on a light-emitting side of the backlight module, and the backlight module comprises:
a light source comprising a circuit board and a plurality of light-emitting chips, wherein the plurality of light-emitting chips are disposed on the circuit board; and
a light guide plate comprising a side surface, a light-emitting surface, and a bottom surface opposite to the light-emitting surface, wherein opposite ends of the side surface are respectively connected to the light-emitting surface and the bottom surface, and wherein the light guide plate further comprises at least one groove defined on the side surface, and the at least one groove accommodates the plurality of light-emitting chips.

11. The display panel of claim 10, wherein each light-emitting chip is in direct contact with an inner wall of each groove.

12. The display panel of claim 10, wherein each groove is filled with an optical adhesive, and each light-emitting chip is encapsulated in the groove by the optical adhesive.

13. The display panel of claim 12, wherein a refractive index of the optical adhesive and a refractive index of the light guide plate are both greater than or equal to 1.5 and less than or equal to 1.55.

14. The display panel of claim 12, wherein in a length direction of the circuit board, the groove penetrates from one end of the side surface of the light guide plate to another end of the side surface.

15. The display panel of claim 10, wherein a number of the at least one groove is plural, and the plurality of grooves are distributed at intervals along a length direction of the circuit board.

16. The display panel of claim 11, wherein the light source comprises a plurality of light-emitting units, wherein the plurality of light-emitting chips comprise a red light-emitting chip, a green light-emitting chip, and a blue light-emitting chip, wherein the plurality of light-emitting units comprise at least two of the red light-emitting chip, the green light-emitting chip, or the blue light-emitting chip; and
wherein each groove accommodates at least one of the plurality of light-emitting units.

17. The display panel of claim 10, further comprising a casing, wherein the casing comprises a bottom plate and a side plate, and wherein the bottom plate and the side plate are encircled to form an accommodating groove, and both the light source and the light guide plate are arranged in the accommodating groove.

18. The display panel of claim 17, wherein the side surface of the light guide plate faces an inner wall of the side plate.

19. The display panel of claim 10, wherein the main body comprises a display area, and a minimum distance between the display area and an edge of the backlight module is less than or equal to 1.5 mm.

20. The display panel of claim 10, wherein the main body comprises a color filter substrate, an array substrate disposed opposite to the color filter substrate, and a liquid crystal layer disposed between the color filter substrate and the array substrate.
